(19) United States
(12) Patent Application Publication
(10) Pub. No.: US 2019/0048940 A1
(43) Pub. Date: Feb. 14, 2019

(54) DAMPER DEVICE

(71) Applicant: AISIN AW CO., LTD., Anjo-shi, Aichi-ken (JP)

(72) Inventors: Kazuyoshi ITO, Tsushima (JP); Hiroki NAGAI, Anjo (JP); Masaki WAJIMA, Nagoya (JP); Kazuhiro ITOU, (US)

(73) Assignee: AISIN AW CO., LTD., Anjo-shi, Aichi-ken (JP)

(21) Appl. No.: 16/076,671

(22) PCT Filed: Mar. 15, 2017
(86) PCT No.: PCT/JP2017/010373

§ 371 Date: Aug. 8, 2018

(30) Foreign Application Priority Data
Mar. 16, 2016 (JP) 2016-052717

(51) Int. Cl. F16D 3/12; F16F 15/134

(52) U.S. Cl. CPC F16D 3/12; F16H 45/02; F16F 15/134; F16F 15/13469

(57) ABSTRACT

The overall size of a damper device having two transmission paths is reduced. A damper device including an input element to which torque from an engine is transmitted and an output element includes: a first intermediate element; a second intermediate element; a first elastic body disposed between the input element and the first intermediate element; a second elastic body disposed between the first intermediate element and the output element; a third elastic body disposed between the input element and the second intermediate element; a fourth elastic body disposed between the second intermediate element and the output element; and a fifth elastic body disposed between the first intermediate element and the second intermediate element, wherein attachment radii of the first to fourth elastic bodies are equal.

### TECHNICAL FIELD

The present disclosure relates to a damper device including an input element to which torque from an engine is transmitted and an output element.

### BACKGROUND ART

Conventionally, a double path damper that is used in association with a torque converter is known as this type of damper devices (see, for example, Patent Document 1). In this damper device, a vibration path from an engine and a lock-up clutch to an output hub is divided into two parallel vibration paths. Each of the two vibration paths includes a pair of springs and a separate intermediate flange disposed between the pair of springs.

### RELATED ART DOCUMENT

### Patent Document

Patent Document 1: Published Japanese Translation of PCT Application No. 2012-506006 (JP 2012-506006 A)

### SUMMARY OF THE INVENTION

In the damper device having two vibration paths as described above, four types of springs and two intermediate flanges need to be provided. In the case where each of the four types of springs includes two springs, eight springs need to be provided, which increases the overall size of the damper device.

A primary object of the present disclosure is to reduce the overall size of a damper device having at least two torque transmission paths.

A damper device according to the present disclosure includes an input element to which torque from an engine is transmitted and an output element, the damper device including: a first intermediate element; a second intermediate element; a first elastic body disposed between the input element and the first intermediate element; a second elastic body disposed between the first intermediate element and the output element; a third elastic body disposed between the input element and the second intermediate element; a fourth elastic body disposed between the second intermediate element and the output element; and a fifth elastic body disposed between the first intermediate element and the second intermediate element; wherein attachment radii of the first to fourth elastic bodies are equal.

The damper device according to the present disclosure has two torque transmission paths: a torque transmission path for transmitting torque from the input element to the output element via the first elastic body, the first intermediate element, and the second elastic body, and a torque transmission path for transmitting torque from the input element to the output element via the third elastic body, the second intermediate element, and the fourth elastic body. Other than these, the damper device also has a torque transmission path for transmitting torque from the input element to the output element via the first elastic body, the first intermediate element, the fifth elastic body, the second intermediate element, and the fourth elastic body, and a torque transmission path for transmitting torque from the input element to the output element via the third elastic body, the second intermediate element, the fifth elastic body, the first intermediate element, and the second elastic body. In this damper device, attachment radii of the first to fourth elastic bodies are equal. Thus, the size of the device can be reduced.

### BRIEF DESCRIPTION OF THE DRAWINGS

FIG. 1 is a schematic configuration diagram illustrating a starting device 1 including a damper device 10 according to an embodiment.

FIG. 2 is an explanatory diagram schematically illustrating a section of the damper device 10 according to the embodiment.

FIG. 3 is an explanatory diagram schematically illustrating the arrangement of first to fourth springs SP11 to SP22 of the damper device 10 according to the embodiment.

FIG. 4 is an explanatory diagram schematically illustrating a section of another damper device according to the disclosure.

FIG. 5 is an explanatory diagram schematically illustrating the arrangement plane of first and second springs SP11 and SP12 and the arrangement plane of third and fourth springs SP21 and SP22 of the other damper device according to the disclosure.

FIG. 6 is an explanatory diagram schematically illustrating a section of another damper device according to the disclosure.

FIG. 7 is an explanatory diagram schematically illustrating the arrangement plane of third and fourth springs SP21 to SP22 of the other damper device according to the disclosure.

### MODES FOR CARRYING OUT THE INVENTION

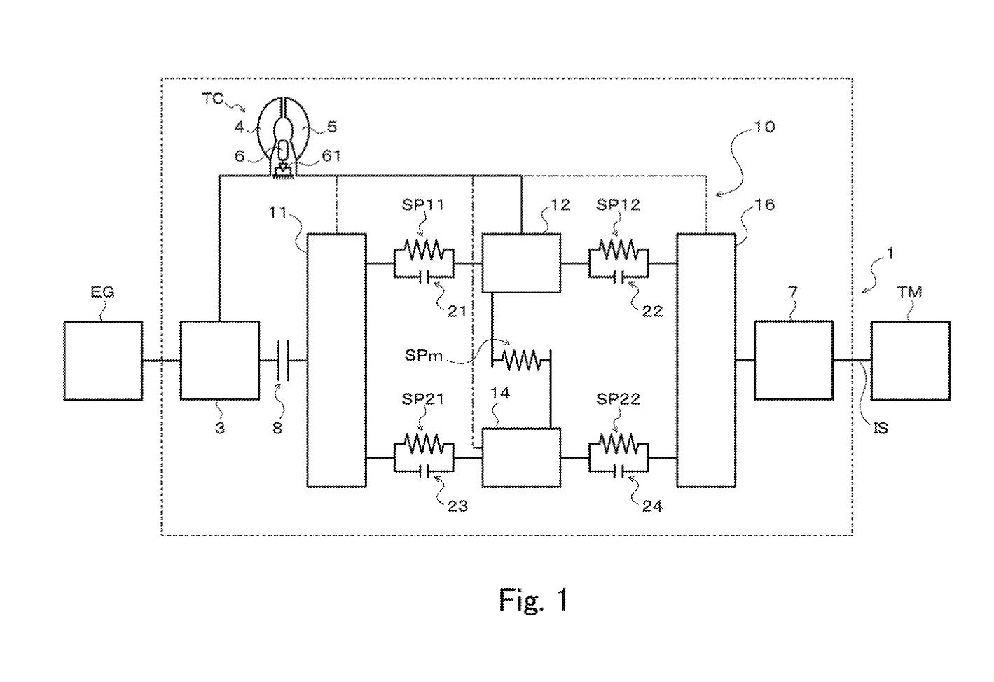

Hereinafter, embodiments of the present disclosure will be described. FIG. 1 is a schematic configuration diagram illustrating a starting device 1 including a damper device 10 according to the present disclosure. The illustrated starting device 1 is mounted on a vehicle including an engine (internal combustion engine in the present embodiment) EG as a motor. The starting device 1 includes, other than the damper device 10: a front cover 3 coupled to a crankshaft of the engine EG, a torque converter (fluid transmission device) TC attached to the front cover 3; a damper hub 7 as a power output member that is coupled to the damper device 10 and fixed to an input shaft IS of a transmission (power transmission device) TM, which is an automatic transmission (AT), a continuously variable transmission (CVT), a dual-clutch transmission (DCT), a hybrid transmission, or a reducer; and a lock-up clutch 8. The torque converter TC includes a pump impeller (input-side fluid transmission element) 4 that is fixed to the front cover 3, a turbine runner (output-side fluid transmission element) 5 that is rotatable coaxially with the pump impeller 4 and fixed to a first intermediate member 12 as will be described below in the present disclosure, a stator 6 that adjusts the flow of hydraulic oil (hydraulic fluid) from the turbine runner 5 to the pump impeller 4, and a one-way clutch 61 that controls the rotational direction of the stator 6. The lock-up clutch 8 performs a lock-up operation that couples the front cover 3 to the damper hub 7 via the damper device 10, and an operation that releases the lock-up.

In the following description, the “axial direction” basically refers to the direction in which a central axis CA (axis) of the starting device 1 and the damper device 10 extends, unless otherwise specified. The “radial direction” basically refers to the radial direction of rotary elements of the damper device 10 and so on, that is, the extending direction of a straight line that extends from the central axis CA in a direction (direction of the radius) orthogonal to the central axis CA, unless otherwise specified. The “circumferential direction” basically refers to the circumferential direction of the damper device 10 and so on, that is, the direction along the rotational direction of the rotary elements, unless otherwise specified.

The damper device 10 damps vibration between the engine EG and the transmission TM. As illustrated in FIG. 1, the damper device 10 includes, as rotary elements (rotary members, that is, rotary mass bodies) that rotate relatively and coaxially, a drive member (input element) 11, the first intermediate member (first intermediate element) 12, a second intermediate member (second intermediate element) 14, and a driven member (output element) 16. The damper device 10 further includes, as torque transmission elements (torque transmission elastic bodies), a plurality of (two in the present embodiment) first springs (first elastic bodies) SP11 that are disposed between the drive member 11 and the first intermediate member 12 to transmit rotational torque (torque in the rotational direction), a plurality of (two in the present embodiment) second springs (second elastic bodies) SP12 that are disposed between the first intermediate member 12 and the driven member 16 to transmit rotational torque, a plurality of (two in the present embodiment) third springs (third elastic bodies) SP21 that are disposed between the drive member 11 and the second intermediate member 14 to transmit rotational torque, a plurality of (two in the present embodiment) fourth springs (fourth elastic bodies) SP22 that are disposed between the second intermediate member 14 and the driven member 16 to transmit rotational torque, and a plurality of (four in the present embodiment) intermediate springs (fifth elastic bodies) SPm that are disposed between the first intermediate member 12 and the second intermediate member 14 to transmit rotational torque.

In the present embodiment, the first to fourth springs SP11 to SP22 and the intermediate springs SPm may be linear coil springs each made of a metal material that is wound in a helical shape so as to have an axis extending straight when not subjected to a load. Note that at least one of the first to fourth springs SP11 to SP22 may be an arc coil spring.

The damper device 10 has two torque transmission paths that do not pass through the intermediate springs SPm: a torque transmission path for transmitting torque from the drive member 11 to the driven member 16 via the first springs SP11, the first intermediate member 12, and the second springs SP12, and a torque transmission path for transmitting torque from the drive member 11 to the driven member 16 via the third springs SP21, the second intermediate member 14, and the fourth springs SP22. The damper device 10 also has two torque transmission paths that pass through the intermediate springs SPm: a torque transmission path for transmitting torque from the drive member 11 to the driven member 16 via the first springs SP11, the first intermediate member 12, the intermediate springs SPm, the second intermediate member 14, and the fourth springs SP22, and a torque transmission path for transmitting torque from the drive member 11 to the driven member 16 via the third springs SP21, the second intermediate member 14, the intermediate springs SPm, the first intermediate member 12, and the second springs SP12.

As illustrated in FIG. 1, the damper device 10 further includes a first stopper 21 that restricts relative rotation between the drive member 11 and the first intermediate member 12 and deflection of the first springs SP11, a second stopper 22 that restricts relative rotation between the first intermediate member 12 and the driven member 16 and deflection of the second springs SP12, a third stopper 23 that restricts relative rotation between the drive member 11 and the second intermediate member 14 and deflection of the third springs SP21, and a fourth stopper 24 that restricts relative rotation of the second intermediate member 14 and the driven member 16 and deflection of the fourth springs SP22.

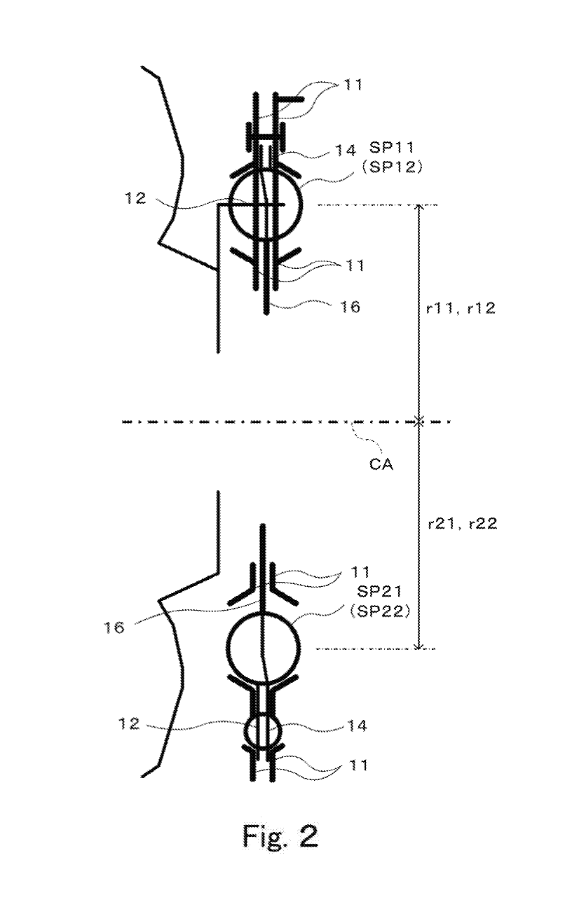

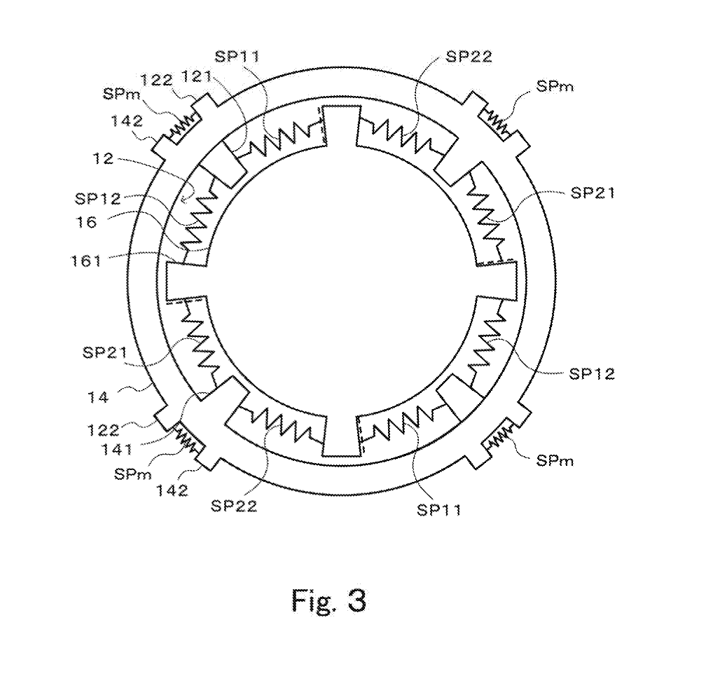

FIG. 2 is an explanatory diagram schematically illustrating a section of the damper device 10 according to the embodiment, and FIG. 3 is an explanatory diagram schematically illustrating the arrangement of the first to fourth springs SP11 to SP22 of the damper device 10 according to the embodiment. In FIG. 3, the driven member 16 is disposed over the disc-shaped drive member 11 at the center. The second intermediate member 14 having the same shape as the annular first intermediate member 12 is disposed radially outward of the drive member 11 and the driven member 16 so as to be positioned over the annular first intermediate member 12 and rotated by 90 degrees with respect thereto. The second intermediate member 14 is disposed concentrically with the drive member 11 and the driven member 16. The drive member 11 has four contact portions 111 extending radially outward and arranged at intervals of 90 degrees. Similarly, the driven member 16 has four contact portions 161 extending radially outward and arranged at intervals of 90 degrees. The first intermediate member 12 has two contact portions 121 extending radially inward and arranged at intervals of 180 degrees, and four contact portions 122 extending radially outward and arranged at intervals of 90 degrees. Similarly, the second intermediate member 14 has two contact portions 141 extending radially inward and arranged at intervals of 180 degrees, and four contact portions 142 extending radially outward and arranged at intervals of 90 degrees to face the contact portions 122 of the first intermediate member 12. The broken lines in FIG. 3 indicate the position of the drive member 11 slightly rotated (turned) about the central axis with respect to the driven member 16 in a direction for moving the vehicle forward.

As illustrated in FIG. 3, the two first springs SP11 are arranged at intervals of 180 degrees such that each of the first springs SP11 is disposed between and in contact with one of the contact portions 111 of the drive member 11 and one of the contact portions 161 of the driven member 16 on one side and one of the contact portions 121 (either one of the contact portions at the upper left and lower right) of the first intermediate member 12 on the other. When the drive member 11 rotates about the central axis with respect to the driven member 16 in the direction for moving the vehicle forward, each of the first springs SP11 is contracted by forces applied from the contact portion 111 of the drive member 11 and the contact portion 121 of the first intermediate member 12. The two second springs SP12 are arranged at intervals of 180 degrees such that each of the second springs SP12 is disposed between and in contact with the one of the contact portions 121 of the first intermediate member 12 on one side and one of the contact portions 111 of the drive member 11 and one of the contact portions 161 of the driven member 16 on the other. When the drive member 11 rotates about the central axis with respect to the driven member 16 in the direction for moving the vehicle forward, each of the second springs SP12 is contracted by forces applied from the contact portion 121 of the first intermediate member 12 subjected to a biasing force of the first spring SP11, and from the contact portion 161 of the driven member 16. The two third springs SP21 are arranged at intervals of 180 degrees such that each of the third springs SP21 is disposed between and in contact with one of the contact portions 111 of the drive member 11 and one of the contact portions 161 of the driven member 16 on one side and one of the contact portions 141 (either of one the contact portions at the lower left and upper right) of the second intermediate member 14 on the other. When the drive member 11 rotates about the central axis with respect to the driven member 16 in the direction for moving the vehicle forward, each of the third springs SP21 is contracted by forces applied from the contact portion 111 of the drive member 11 and the contact portion 141 of the second intermediate member 14. The two fourth springs SP22 are arranged at intervals of 180 degrees such that each of the fourth springs SP22 is disposed between and in contact with the one of the contact portions 141 of the second intermediate member 14 on one side and one of the contact portions 111 of the drive member 11 and one of the contact portions 161 of the driven member 16 on the other. When the drive member 11 rotates about the central axis with respect to the driven member 16 in the direction for moving the vehicle forward, each of the fourth springs SP22 is contracted by forces applied from the contact portion 141 of the second intermediate member 14 subjected to a biasing force of the third spring SP21, and from the contact portion 161 of the driven member 16. The four intermediate springs SPm are arranged at intervals of 90 degrees such that each of the third springs SP21 is disposed between and in contact with one of the contact portions 121 of the first intermediate member 12 and one of the contact portions 142 of the second intermediate member 14. When the contact portion 122 of the first intermediate member 12 and the contact portion 142 of the second intermediate member 14 rotate relative to each other, each of the intermediate springs SPm is expanded or contracted.

As illustrated in FIGS. 2 and 3, the first to fourth springs SP11 to SP22 are disposed such that attachment radii r11 to r22, which are the distances from the central axis CA of the damper device 10 to the axes of the respective first to fourth springs SP11 to SP22, are equal. Further, the first to fourth springs SP11 to SP22 are disposed such that the axes thereof are arranged in the same plane. Further, the intermediate springs SPm are disposed radially outward of the first to fourth springs SP11 to SP22 such that the axes thereof are arranged in the same plane as the axes of the first to fourth springs SP11 to SP22. With this arrangement, five types of springs (first to fourth springs SP11 to SP22 and the intermediate springs SPm) can be compactly arranged, and the axial length of the damper device 10 can be reduced.

In the damper device 10 of the present embodiment, the first intermediate member 12 is coupled to the turbine runner 5 of the torque converter TC to rotate therewith. However, the configuration is not limited thereto. That is, as indicated by the long dashed double-short dashed line in FIG. 1, the drive member 11 or the driven member 16 may be coupled to the turbine runner 5 to rotate therewith, and the second intermediate member 14 may be coupled to the turbine runner 5 to rotate therewith.

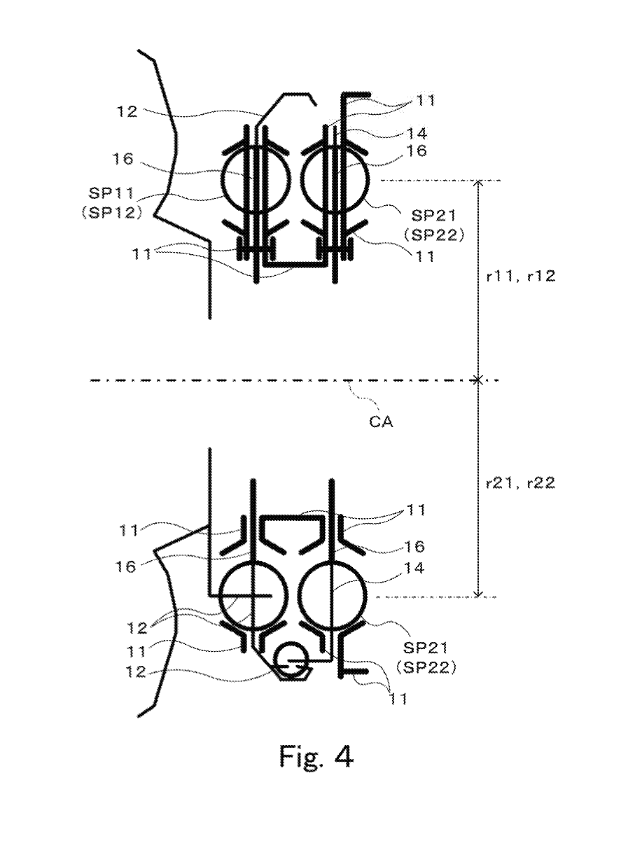

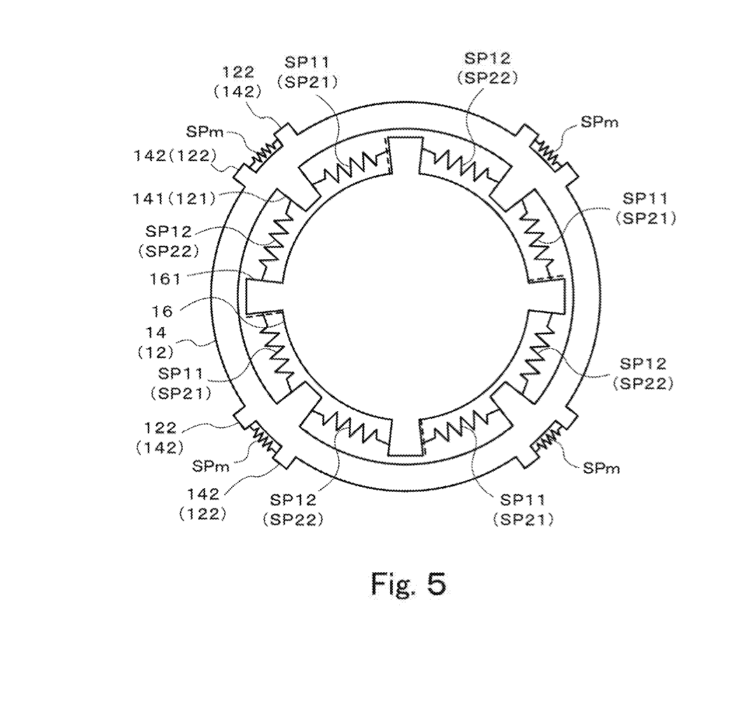

FIG. 4 is an explanatory diagram schematically illustrating a section of another damper device according to the disclosure, and FIG. 5 is an explanatory diagram illustrating the arrangement plane of the first and second springs SP11 and SP12 and the arrangement plane of the third and fourth springs SP21 and SP22 of the other damper device according to the disclosure. In FIG. 5, the driven member 16 is disposed over the disc-shaped drive member 11 at the center. The annular first intermediate member 12 or second intermediate member 14 is disposed radially outward of the drive member 11 and the driven member 16 so as to be concentric therewith. The drive member 11 has four contact portions 111 extending radially outward and arranged at intervals of 90 degrees.

Similarly, the driven member 16 has four contact portions 161 extending radially outward and arranged at intervals of 90 degrees. The first intermediate member 12 has four contact portions 121 extending radially inward and arranged at intervals of 90 degrees, and four contact portions 122 extending radially outward in the vicinity of the respective contact portions 121. Similarly, the second intermediate member 14 has four contact portions 141 extending radially inward and arranged at intervals of 90 degrees, and four contact portions 142 extending radially outward in the vicinity of the respective contact portions 141 to face the contact portions 122 of the first intermediate member 12. The broken lines in FIG. 5 indicate the position of the drive member 11 slightly rotated (turned) about the central axis with respect to the driven member 16 in a direction for moving the vehicle forward.

As illustrated in FIG. 5, in this damper device, the four first springs SP11 are arranged at intervals of 90 degrees such that each of the first springs SP11 is disposed between and in contact with one of the contact portions 111 of the drive member 11 and one of the contact portions 161 of the driven member 16 on one side and one of the contact portions 121 of the first intermediate member 12 on the other. When the drive member 11 rotates about the central axis with respect to the driven member 16 in the direction for moving the vehicle forward, each of the first springs SP11 is contracted by forces applied from the contact portion 111 of the drive member 11 and the contact portion 121 of the first intermediate member 12. The four second springs SP12 are arranged at intervals of 90 degrees such that each of the second springs SP12 is disposed between and in contact with the one of the contact portions 121 of the first intermediate member 12 on one side and one of the contact portions 111 of the drive member 11 and one of the contact portions 161 of the driven member 16 on the other. When the drive member 11 rotates about the central axis with respect to the driven member 16 in the direction for moving the vehicle forward, each of the second springs SP12 is contracted by forces applied from the contact portion 121 of the first intermediate member 12 subjected to a biasing force of the first spring SP11, and from the contact portion 161 of the driven member 16. The four third springs SP21 are arranged at intervals of 90 degrees such that each of the third springs SP21 is disposed between and in contact with one of the contact portions 111 of the drive member 11 and one of the contact portions 161 of the driven member 16 on one side and one of the contact portions 141 of the second intermediate member 14 on the other. When the drive member 11 rotates about the central axis with respect to the driven member 16 in the direction for moving the vehicle forward, each of the third springs SP21 is contracted by forces applied from the contact portion 111 of the drive member 11 and the contact portion 141 of the second intermediate member 14. The four fourth springs SP22 are arranged at intervals of 90 degrees such that each of the fourth springs SP22 is disposed between and in contact with the one of the contact portions 141 of the second intermediate member 14 on one side and one of the contact portions 111 of the drive member 11 and one of the contact portions 161 of the driven member 16 on the other. When the drive member 11 rotates about the central axis with respect to the driven member 16 in the direction for moving the vehicle forward, each of the fourth springs SP22 is contracted by forces applied from the contact portion 141 of the second intermediate member 14 subjected to a biasing force of the third spring SP21, and from the contact portion 161 of the driven member 16. The four intermediate springs SPm are arranged at intervals of 90 degrees such that each of the third springs SP21 is disposed between and in contact with one of the contact portions 122 of the first intermediate member 12 and one of the contact portions 142 of the second intermediate member 14. When the contact portion 122 of the first intermediate member 12 and the contact portion 142 of the second intermediate member 14 rotate relative to each other, each of the intermediate springs SPm is expanded or contracted.

As illustrated in FIGS. 4 and 5, the first to fourth springs SP11 to SP22 are disposed such that attachment radii r11 to r22, which are the distances from the central axis CA of the damper device 10 to the axes of the respective first to fourth springs SP11 to SP22, are equal. Further, the first and second springs SP11 and SP12 are disposed such that the axes thereof are arranged in the same plane. The third and fourth springs SP21 and SP22 are disposed spaced from the first and second springs SP11 and SP12 by a minimum distance in the axial direction such that the axes thereof are arranged in the same plane that is different from the plane in which the axes of the first and second springs SP11 and SP12 are arranged. Further, the intermediate springs SPm are disposed radially outward of the first to fourth springs SP11 to SP22 such that the axes thereof are arranged in the same plane that is disposed between the plane of the axes of the first and second springs SP11 and SP12 and the plane of the axes of the third and fourth springs SP21 and SP22. With this arrangement, five types of springs (first to fourth springs SP11 to SP22 and the intermediate springs SPm) can be compactly arranged. Thus, compared to the damper device 10 illustrated in FIGS. 2 and 3, although the axial length is slightly increased, the radial length can be reduced. Accordingly, space for the clutch and other components can be secured outside the first to fourth springs SP11 to SP22 in the radial direction. Further, it is possible to increase the degree of freedom in arrangement and rigidity (performance) of the first to fourth springs SP11 to SP22 and the intermediate springs SPm. Note that although the distance between the plane in which the third and fourth springs SP21 and SP22 are arranged and the plane in which the first and second springs SP11 and SP12 are arranged is the minimum distance, the distance may be slightly greater than the minimum distance.

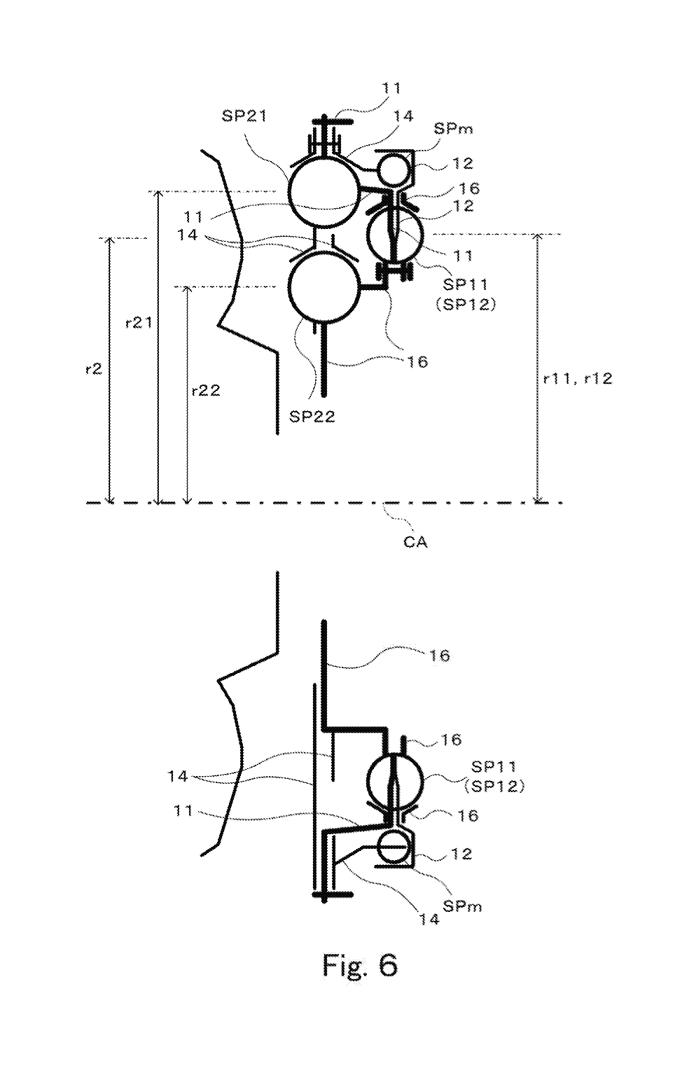

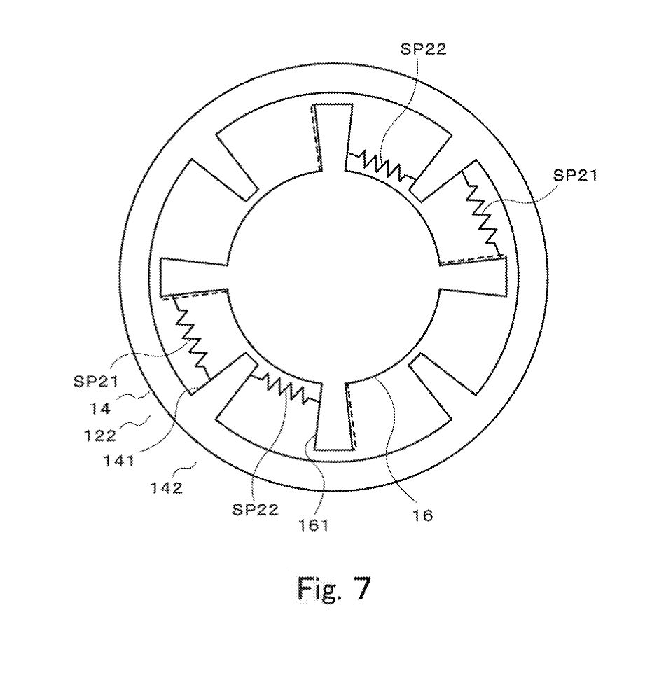

FIG. 6 is an explanatory diagram schematically illustrating a section of another damper device according to the disclosure, and FIG. 7 is an explanatory diagram schematically illustrating the arrangement plane of the third and fourth springs SP21 and SP22 of the other damper device according to the disclosure. The arrangement plane of the first and second springs SP11 and SP12 of this damper device is the same as that illustrated in FIG. 5. In FIG. 7, the driven member 16 is disposed over the disc-shaped drive member 11 at the center. The annular first intermediate member 12 or second intermediate member 14 is disposed radially outward of the drive member 11 and the driven member 16 so as to be concentric therewith. The drive member 11 has four contact portions 111 extending radially outward and arranged at intervals of 90 degrees. Similarly, the driven member 16 has four contact portions 161 extending radially outward and arranged at intervals of 90 degrees. The second intermediate member 14 has four contact portions 141 extending radially inward and arranged at intervals of 90 degrees. Note that the broken lines in FIG. 7 indicate the position of the drive member 11 slightly rotated (turned) about the central axis with respect to the driven member 16 in a direction for moving the vehicle forward.

As illustrated in FIG. 7, in this damper device, the two third springs SP21 are arranged at intervals of 180 degrees such that each of the third springs SP21 is disposed between and in contact with a distal end portion of one of the contact portions 111 of the drive member 11 and a distal end portion of one of the contact portions 161 of the driven member 16 on one side and a proximal end portion of one of the contact portions 141 of the second intermediate member 14 on the other. When the drive member 11 rotates about the central axis with respect to the driven member 16 in the direction for moving the vehicle forward, each of the third springs SP21 is contracted by forces applied from the contact portion 111 of the drive member 11 and the contact portion 141 of the second intermediate member 14. The two fourth springs SP22 are arranged at intervals of 180 degrees such that each of the fourth springs SP22 is disposed between and in contact with a distal end portion of the one of the contact portions 141 of the second intermediate member 14 on one side and a proximal end portion of one of the contact portions 111 of the drive member 11 and a proximal end portion of one of the contact portions 161 of the driven member 16 on the other. When the drive member 11 rotates about the central axis with respect to the driven member 16 in the direction for moving the vehicle forward, each of the fourth springs SP22 is contracted by forces applied from the contact portion 141 of the second intermediate member 14 subjected to a biasing force of the third spring SP21, and from the contact portion 161 of the driven member 16. For ease of understanding, there are spaces radially inward of the third springs SP21 and radially outward of the fourth springs SP22 in FIG. 7. However, in reality, there are only spaces for the third springs SP21 and the fourth springs SP22.

As illustrated in FIG. 6, the first and second springs SP11 and SP12 are disposed such that the attachment radii r11 and r12, which are the distances from the central axis CA of the damper device 10 to the respective axes of the first and second springs SP11 and SP12, are equal. Further, the first and second springs SP11 and SP12 are disposed such that the axes thereof are arranged in the same plane. The third and fourth springs SP21 and SP22 are disposed such that an average attachment radius r2 (r2=(r21+r22)/2), which is the average of the attachment radii r21 and r22, is equal to the attachment radii r11 and r12 of the first and second springs SP11 and SP12, and such that the axes thereof are arranged in the same plane that is different from the plane in which the axes of the first and second springs SP11 and SP12 are arranged. That is, the fourth springs SP22 are disposed inside the third springs SP21, and the first and second springs SP11 and SP12 are arranged in the middle between the third and fourth springs SP21 and SP22, and are spaced therefrom by a minimum distance in the axial direction. The intermediate springs SPm are disposed radially outward of the first and second springs SP11 and SP12 such that the axes thereof are arranged in the same plane as the axes of the first and second springs SP11 and SP12. With this arrangement, five types of springs (first to fourth springs SP11 to SP22 and the intermediate springs SPm) can be compactly arranged. Thus, compared to the damper device 10 illustrated in FIGS. 2 and 3, although the axial length is slightly increased, the radial length can be reduced. Further, compared to the damper device illustrated in FIGS. 4 and 5, although the radial length is slightly increased, the axial length can be reduced. Further, it is possible to increase the degree of freedom in arrangement and rigidity (performance) of the first to fourth springs SP11 to SP22. Note that although the first and second springs SP11 and SP12 are arranged in the middle between the third and fourth springs SP21 and SP22, and are spaced therefrom by the minimum distance in the axial direction, the distance between the plane in which the first and second springs SP11 and SP12 are arranged and the plane in which the third and fourth springs SP21 and SP22 are arranged may be slightly greater than the minimum distance.

In another damper device according to the present disclosure, the attachment radius r11 of the first spring SP11 and the attachment radius r12 of the second spring SP12 may be different from each other, and the attachment radius r21 of the third spring SP21 and the attachment radius r22 of the fourth spring SP22 may be different from each other. In this case, an average attachment radius r1 (r1=(r11+r12)/2), which is the average of the attachment radius r11 of the first spring SP11 and the attachment radius r12 of the second spring SP12, and an average attachment radius r2 (r2=(r21+r22)/2), which is the average of the attachment radius r21 of the third spring SP21 and the attachment radius r22 of the fourth spring SP22, need to be equal (r1=r2).

A damper device (10) according to the present disclosure includes an input element (11) to which torque from an engine (EG) is transmitted and an output element (16), the damper device (10) including: a first intermediate element (12); a second intermediate element (14); a first elastic body (SP11) disposed between the input element (11) and the first intermediate element (12); a second elastic body (SP12) disposed between the first intermediate element (12) and the output element (16); a third elastic body (SP21) disposed between the input element (11) and the second intermediate element (14); a fourth elastic body (SP22) disposed between the second intermediate element (14) and the output element (16); and a fifth elastic body (SPm) disposed between the first intermediate element (12) and the second intermediate element (14); wherein attachment radii of the first to fourth elastic bodies (SP11, SP12, SP21, and SP22) are equal.

The damper device (10) according to the present disclosure has two torque transmission paths: a torque transmission path for transmitting torque from the input element (11) to the output element (16) via the first elastic body (SP11), the first intermediate element (12), and the second elastic body (SP12); and a torque transmission path for transmitting torque from the input element (11) to the output element (16) via the third elastic body (SP21), the second intermediate element (14), and the fourth elastic body (SP22). Other than these, the damper device (10) also has a torque transmission path for transmitting torque from the input element (11) to the output element (16) via the first elastic body (SP11), the first intermediate element (12), the fifth elastic body (SPm), the second intermediate element (14), and the fourth elastic body (SP22), and a torque transmission path for transmitting torque from the input element (11) to the output element (16) via the third elastic body (SP21), the second intermediate element (14), the fifth elastic body (SPm), the first intermediate element (12), and the second elastic body (SP12). In this damper device (10), attachment radii of the first to fourth elastic bodies (SP11, SP12, SP21, and SP22) are equal. Thus, the size of the damper device (10) can be reduced.

In the damper device (10) according to the present disclosure, the first to fourth elastic bodies (SP11, SP12, SP21, and SP22) may be arranged in a same plane. Thus, the first to fourth elastic bodies (SP11, SP12, SP21, and SP22) have the same attachment radius and are arranged in the same plane, so that the length of the damper device (10) in the rotational axis direction (axial direction) can be reduced.

In the damper device (10) according to the present disclosure, the first elastic body (SP11) and the second elastic body (SP12) may be arranged in a same plane, and the third elastic body (SP21) and the fourth elastic body (SP22) may be arranged in a same plane that is different from the plane in which the first elastic body (SP11) and the second elastic body (SP12) are arranged. Thus, the first elastic body (SP11) and the second elastic body (SP12) overlap the third elastic body (SP21) and the fourth elastic body (SP22) in the axial direction. Therefore, compared to a damper device in which the first to fourth elastic bodies (SP11, SP12, SP21, and SP22) are arranged in the same plane, although the axial length is increased, the outside diameter can be reduced. Further, it is possible to increase the degree of freedom in arrangement and rigidity (performance) of the first to fourth elastic bodies (SP11, SP12, SP21, and SP22).

In the damper device (10) according to the present disclosure, an attachment radius of the fifth elastic body (SPm) may be greater than the attachment radius of the first to fourth elastic bodies (SP11, SP12, SP21, and SP22). Thus, the fifth elastic body (SPm) is installed radially outward of the first to fourth elastic bodies (SP11, SP12, SP21, and SP22), so that the axial length of the damper device (10) can be reduced.

In the damper device (10) according to the present disclosure, the first elastic body (SP11) and the second elastic body (SP21) may be arranged in a same plane, and the third elastic body (SP21) and the fourth elastic body (SP22) may be arranged in a same plane that is different from the plane in which the first elastic body (SP11) and the second elastic body (SP12) are arranged. Thus, compared to a damper device in which the first to fourth elastic bodies (SP11, SP12, SP21, and SP22) have the same attachment radius and are arranged in the same plane, although the axial length is increased, the outside diameter can be reduced. Further, compared to a damper device in which the first to fourth elastic bodies (SP11, SP12, SP21, and SP22) have the same attachment radius, and the first elastic body (SP11) and the second elastic body (SP12) overlap the third elastic body (SP21) and the fourth elastic body (SP22) in the axial direction, although the outside diameter is increased, the axial length can be reduced. Further, it is possible to increase the degree of freedom in arrangement and rigidity (performance) of the third elastic body (SP21) and the fourth elastic body (SP22).

In the damper device (10) according to the present disclosure, an attachment radius of the fifth elastic body (SPm) may be greater than the attachment radius of the first elastic body (SP11) and the second elastic body (SP12), and the fifth elastic body (SPm) may be arranged in a same plane as the first elastic body (SP11) and the second elastic body (SP12). Thus, the fifth elastic body (SPm) is installed radially outward of the first elastic body (SP11) and the second elastic body (SP12), so that the axial length of the damper device (10) can be reduced.

In the damper device (10) according to the present disclosure, a stopper (21 to 24) that restricts deflection may be attached to at least one of the first to fourth elastic bodies (SP11, SP12, SP21, and SP22). Thus, it is possible to restrict the elastic body with the stopper attached thereto from deflecting more than necessary. Note that stoppers may be attached to all the first to fourth elastic bodies (SP11, SP12, SP21, and SP22).

In the damper device (10) according to the present disclosure, the output element (16) is coupled to an input shaft (IS) of a transmission (TM).

Although embodiments of the present disclosure have been described above, the present disclosure is not limited to these embodiments and may be embodied in various forms without departing from the scope of the present disclosure.

### INDUSTRIAL APPLICABILITY

The present disclosure is applicable in the industry of manufacturing damper devices and the like.

1-8. (canceled)

9. A damper device including an input to which torque from an engine is transmitted and an output, the damper device comprising:
a first intermediate element;
a second intermediate element;
a first elastic body disposed between the input and the first intermediate element;
a second elastic body disposed between the first intermediate element and the output;
a third elastic body disposed between the input and the second intermediate element;
a fourth elastic body disposed between the second intermediate element and the output; and
a fifth elastic body disposed between the first intermediate element and the second intermediate element, wherein
attachment radii of the first to fourth elastic bodies are equal.

10. The damper device according to claim 9, wherein
the first to fourth elastic bodies are arranged in a same plane.

11. The damper device according to claim 9, wherein
the first elastic body and the second elastic body are arranged in a same plane, and the third elastic body and the fourth elastic body are arranged in a same plane that is different from a plane in which the first elastic body and the second elastic body are arranged.

12. The damper device according to claim 9, wherein
an attachment radius of the fifth elastic body is greater than the attachment radius of the first to fourth elastic bodies.

13. The damper device according to claim 11, wherein
an attachment radius of the fifth elastic body is greater than the attachment radius of the first elastic body and the second elastic body, and the fifth elastic body is arranged in a same plane as the first elastic body and the second elastic body.

14. The damper device according to claim 9, wherein
a stopper that restricts deflection is attached to at least one of the first to fourth elastic bodies.

15. The damper device according to claim 9, wherein
the output is coupled to an input shaft of a transmission.

16. The damper device according to claim 10, wherein
an attachment radius of the fifth elastic body is greater than the attachment radius of the first to fourth elastic bodies.

17. The damper device according to claim 10, wherein
a stopper that restricts deflection is attached to at least one of the first to fourth elastic bodies.

18. The damper device according to claim 10, wherein
the output is coupled to an input shaft of a transmission.

19. The damper device according to claim 11, wherein
an attachment radius of the fifth elastic body is greater than the attachment radius of the first to fourth elastic bodies.

20. The damper device according to claim 11, wherein
a stopper that restricts deflection is attached to at least one of the first to fourth elastic bodies.

21. The damper device according to claim 11, wherein
the output is coupled to an input shaft of a transmission.

22. The damper device according to claim 12, wherein
a stopper that restricts deflection is attached to at least one of the first to fourth elastic bodies.

23. The damper device according to claim 12, wherein
the output is coupled to an input shaft of a transmission.

24. The damper device according to claim 14, wherein
the output is coupled to an input shaft of a transmission.

25. The damper device according to claim 16, wherein
a stopper that restricts deflection is attached to at least one of the first to fourth elastic bodies.

26. The damper device according to claim 16, wherein
the output is coupled to an input shaft of a transmission.

27. The damper device according to claim 17, wherein
the output is coupled to an input shaft of a transmission.

28. The damper device according to claim 19, wherein
a stopper that restricts deflection is attached to at least one of the first to fourth elastic bodies.
